(19) United States
(12) Patent Application Publication
(10) Pub. No.: US 2025/0267015 A1
(43) Pub. Date: Aug. 21, 2025

(54) VIRTUAL MICROCONTROLLER FOR DEVICE AUTHENTICATION IN A CONFIDENTIAL COMPUTING ENVIRONMENT

(71) Applicant: Intel Corporation, Santa Clara, CA (US)

(72) Inventors: Jiewen Yao, Shanghai (CN); Vedvyas Shanbhogue, Austin, TX (US); Ravi Sahita, Portland, OR (US)

(73) Assignee: Intel Corporation, Santa Clara, CA (US)

(21) Appl. No.: 18/855,208

(22) PCT Filed: May 31, 2022
(86) PCT No.: PCT/CN2022/096222

§ 371 Date: Oct. 8, 2024

(51) Int. Cl. H04L 9/32; H04L 9/08

(52) U.S. Cl. CPC H04L 9/3265; H04L 9/0861; H04L 9/3271

(57) ABSTRACT

Embodiments are directed to a virtual microcontroller for device authentication in a confidential computing environment. An embodiment includes a processor to implement a service trust domain (TD) as a virtual microcontroller (VMC) trust domain (VMC-TD) for a device, where the VMC-TD is to support protocols for device authentication, device measurement, and device management; and receive a VMC certificate chain that is endorsed by a startup service component comprising at least one of a trusted module of the confidential computing environment, the VMC certificate chain comprising a root certificate of the startup service component, a startup services module signing certificate, and a full VMC certificate comprising the initial VMC certificate and a TD report comprising a measurement of the device.

### FIELD

This disclosure relates generally to confidential computing and more particularly to a virtual microcontroller for device authentication in a confidential computing environment.

### BACKGROUND

Traditionally, devices have added functionality over time, such as adding acceleration for data transformation, offloading functionality from the CPU (central processing unit) to the device, etc. This process also adds complexity to the device in order to preserve performance and security. Examples of such an evolution can be seen in devices such as network controllers, storage controllers, FPGAs (field programmable gate arrays), and graphics devices. Today's devices also need to be efficiently shared for multi-tenant usages such as cloud, virtualization, containers, etc. These multi-tenancy requirements are also enforced via specialized engines on the devices to enforce separation of privileges, data path, and secure arbitration. Examples of this evolution are observed in virtualized IO (input/output) from direct device assignment (DDA), SR-IOV (Single-root Input-Output Virtualization), and SIOV (Scalable IO Virtualization).

TDX or Trust Domain Extensions are instructions in a CPU instruction set architecture (ISA) to remove a virtual machine monitor (VMM) from the trusted computing base (TCB) of cloud-computing virtual machine (VM) workloads (called Trust Domains or TDs). Generally, a TCB comprises a set of hardware, firmware, and software components that are implemented on a platform to provide a secure environment including a portion of the platform's memory address space that is used by the TCB.

A TDX IO model extends the TDX architecture to allow a VMM outside the TCB to manage devices that can be securely assigned to a TD. TDX IO enables a device to be securely assigned to the TD such that the data on the link is protected against confidentiality, integrity, and replay attacks. TDX IO also enforces IOMMU (IO memory management unit) properties such that a device could use direct memory access (DMA) directly to a TD's private memory if the TD accepted an interface for a measured device.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 illustrates a computing device for providing a virtual microcontroller for device authentication in a confidential computing environment, in accordance with implementations herein.

FIG. 2 illustrates a computing environment for providing a virtual microcontroller for device authentication in a confidential computing environment, in accordance with implementations herein.

FIG. 3 illustrates a block diagram of confidential computing environment for virtual microcontroller trust domain (VMC-TD) certificate generation, in accordance with implementations herein.

FIG. 4 illustrates the generation of the full VMC certificate chain by a system-on-a-chip (SoC) secure startup service module, in accordance with implementations herein.

FIG. 5 illustrates a block diagram of confidential computing environment for device authentication, in accordance with implementations herein.

FIG. 6 illustrates a block diagram of confidential computing environment for virtual device measurement and management, in accordance with implementations herein.

FIG. 7 is a block diagram illustrating a confidential computing environment implementing seamless update of an entire VMC-TD, in accordance with implementations herein.

FIG. 8 is a block diagram illustrating a confidential computing environment implementing seamless update of a portion (mutable portion) of a VMC-TD, in accordance with implementations herein.

FIG. 9 is a flow diagram illustrating operations for providing a virtual microcontroller for a device in a confidential computing environment, according to implementations of the disclosure.

FIG. 10 is a flow diagram illustrating operations for providing a virtual microcontroller for device authentication in a confidential computing environment, according to implementations of the disclosure.

FIG. 11 is a flow diagram illustrating operations for providing a virtual microcontroller for device management in a confidential computing environment, according to implementations of the disclosure.

FIG. 12 is a flow diagram illustrating operations for providing seamless update for a virtual microcontroller of a device in a confidential computing environment, according to implementations of the disclosure.

FIG. 13 is a schematic diagram of an illustrative electronic computing device to enable a virtual microcontroller for device authentication in a confidential computing environment, according to some implementations.

### DETAILED DESCRIPTION

Embodiments described herein are directed to a virtual microcontroller for device authentication in a confidential computing environment.

In embodiments herein, a confidential computing environment may include a Trust Domain Extensions (TDX) confidential computing environment. In some embodiments, a confidential computing environment may include other confidential computing architectures, such as secure encrypted virtualization (SEV).

TDX includes instructions in a CPU instruction set architecture (ISA) to remove a virtual machine monitor (VMM) from the trusted computing base (TCB) of cloud-computing virtual machine (VM) workloads (called Trust Domains or TDs). Generally, a TCB comprises a set of hardware, firmware, and software components that are implemented on a platform to provide a secure environment including a portion of the platform's memory address space that is used by the TCB. A TDX-IO model extends the TDX architecture to allow a VMM outside the TCB to manage devices that can be securely assigned to a TD. TDX-IO enables a device to be securely assigned to the TD such that the data on the link is protected against confidentiality, integrity, and replay attacks. TDX-IO also enforces IOMMU (IO memory management unit) properties such that a device could use direct memory access (DMA) directly to a TD's private memory if the TD accepted an interface for a measured device.

In conventional computing systems, in order to establish a trust relationship between the device and TD, TDX-IO architecture dictates that the TD and the Trusted Execution Environment (TEE) security manager (TSM) utilize DMTF Secure Protocol and Data Model (SPDM) to authenticate the device and collect device measurement, and utilize PCI-SIG trusted execution environment (TEE) Device Interface Security Protocol (TDISP) to manage the device's function(s). As a result, if a device is to be used in a TDX-IO environment, the device should implement both the SPDM protocol and the TDISP protocol, for example.

However, in order to support the SPDM/TDISP protocols, the device should include a root-of-trust (RoT) for storage (RTS) to access the device private security (such as a private key), a root-of-trust for measurement (RTM) to record the device measurement, and a root-of-trust for report (RTR) to report the SPDM measurement. The device also should include storage space for the SPDM certificate chain. Furthermore, the device should include logic to implement the SPDM protocol and the TDISP protocol (which are usually written in software such as C programming language, RUST, or ADA). Finally, the device should have a microcontroller for the firmware and the corresponding secure firmware update mechanism.

However, in today's computing environments, an integrated device may be a simple device. For example, an integrated device in a system-on-a-chip (SoC) environment may include solely a hardware RTL (Register Transfer Level) written in Verilog or VHDL. As such, it can be burdensome and difficult for such an integrated device to support a complex protocol, such as the SPDM protocol or TDISP protocol discussed above. Furthermore, in an example SoC environment, there may be multiple simple integrated devices with which trust relationships are to be established with a TD. In this case, providing the storage space and complex logic to support establishing the trust relationship can be inefficient in terms of processing resources and space.

Implementations herein provide for a virtual microcontroller for device authentication in a confidential computing environment. A special service TD is implemented as a virtual microcontroller (VMC) for the integrated device. This special service TD is referred to herein as a VMC-TD. A service TD may be software that has minimal impact on existing devices in the computing environment. A service TD allows for added support on top of an existing integrated device, such as a small integrated device on an SoC. A service TD can be updated without impacting hardware. In case that a vulnerability is found in a service TD, the service TD can be stopped (e.g., torn down, teardown) and a new service TD can be launched again. Furthermore, a service TD does not have limitation on memory size. For example, the service TD can declare the memory usage, then the VMM can assign enough memory for it.

In implementations herein, the VMC-TD can be treated as the part of a Chain-of-Trust (CoT) for the device. The VMC-TD can include protocols (e.g., SPDM/TDISP protocols) to establish communication with the TD and TSM and establish a trust relationship. In some implementations, the VMC-TD may not have a private key. Instead, the VMC-TD may generate an alias key pair and certificate at runtime and ask a known trusted module, such as secure startup service module (S3M), to be an endorser to sign the certificate.

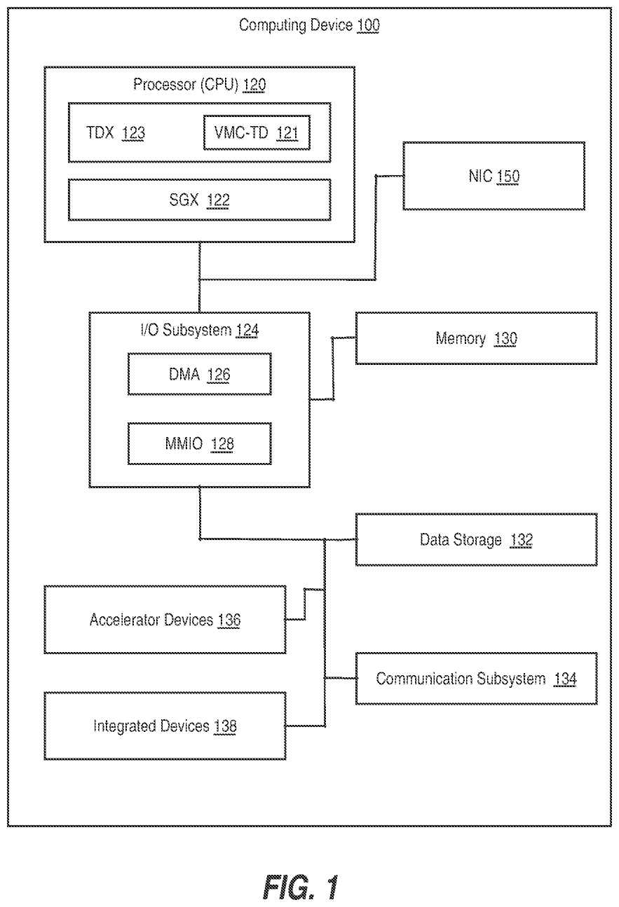

FIG. 1 illustrates a computing device 100 for providing a virtual microcontroller for device authentication in a confidential computing environment, in accordance with implementations herein. In one implementation, computing device 100 includes a processor 120, an accelerator device 136, and an integrated device 138. The accelerator device 136 can include, but is not limited to, a graphics processing unit (GPU), a field-programmable gate array (FPGA), an application-specific integrated circuit (ASIC), a data streaming accelerator (DSA), and so on.

The computing device 100 may be embodied as any type of device capable of performing the functions described herein. For example, the computing device 100 may be embodied as, without limitation, a computer, a laptop computer, a tablet computer, a notebook computer, a mobile computing device, a smartphone, a wearable computing device, a multiprocessor system, a server, a workstation, and/or a consumer electronic device. As shown in FIG. 1, the illustrative computing device 100 includes a processor 120, an I/O subsystem 124, a memory 130, and a data storage device 132. Additionally, in some embodiments, one or more of the illustrative components may be incorporated in, or otherwise form a portion of, another component. For example, the memory 130, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. As shown, the processor 120 illustratively includes secure enclave support 122, which allows the processor 120 to establish a trusted execution environment known as a secure enclave, in which executing code may be measured, verified, and/or otherwise determined to be authentic. Additionally, code and data included in the secure enclave may be encrypted or otherwise protected from being accessed by code executing outside of the secure enclave. For example, code and data included in the secure enclave may be protected by hardware protection mechanisms of the processor 120 while being executed or while being stored in certain protected cache memory of the processor 120. The code and data included in the secure enclave may be encrypted when stored in a shared cache or the main memory 130.

The secure enclave support 122 may be embodied as a set of processor instruction extensions that allows the processor 120 to establish one or more secure enclaves in the memory 130. For example, the secure enclave support 122 may be embodied as Intel® Software Guard Extensions (SGX) technology. In other embodiments, processor 120 may include trusted domains (TDs) embodied as Intel® Trusted Domain Extensions (TDX) 123 technology that is implemented to isolate virtual machines from the virtual machine monitor and other virtual machines operating on the computing device 100.

The memory 130 may be embodied as any type of volatile or non-volatile memory or data storage capable of performing the functions described herein. In operation, the memory 130 may store various data and software used during operation of the computing device 100 such as operating systems, applications, programs, libraries, and drivers. As shown, the memory 130 may be communicatively coupled to the processor 120 via the I/O subsystem 124, which may be embodied as circuitry and/or components to facilitate input/output operations with the processor 120, the memory 130, and other components of the computing device 100. For example, the I/O subsystem 124 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 130 may be directly coupled to the processor 120, for example via an integrated memory controller hub. Additionally, in some embodiments, the I/O subsystem 124 may form a portion of a system-on-a-chip (SoC) and be incorporated, along with the processor 120, the memory 130, the accelerator device 136, the integrated device 138, and/or other components of the computing device 100, on a single integrated circuit chip. Additionally, or alternatively, in some embodiments the processor 120 may include an integrated memory controller and a system agent, which may be embodied as a logic block in which data traffic from processor cores and I/O devices converges before being sent to the memory 130.

As shown, the I/O subsystem 124 includes a direct memory access (DMA) engine 126 and a memory-mapped I/O (MMIO) engine 128. The processor 120, including secure enclaves established with the secure enclave support 122, may communicate with the integrated device 138 with one or more DMA transactions using the DMA engine 126 and/or with one or more MMIO transactions using the MMIO engine 128. The computing device 100 may include multiple DMA engines 126 and/or MMIO engines 128 for handling DMA and MMIO read/write transactions based on bandwidth between the processor 120 and the integrated device 138. Although illustrated as being included in the I/O subsystem 124, it should be understood that in some embodiments the DMA engine 126 and/or the MMIO engine 128 may be included in other components of the computing device 100 (e.g., the processor 120, memory controller, or system agent), or in some embodiments may be embodied as separate components.

The data storage device 132 may be embodied as any type of device or devices configured for short-term or long-term storage of data such as, for example, memory devices and circuits, memory cards, hard disk drives, solid-state drives, non-volatile flash memory, or other data storage devices. The computing device 100 may also include a communications subsystem 134, which may be embodied as any communication circuit, device, or collection thereof, capable of enabling communications between the computing device 100 and other remote devices over a computer network (not shown). The communications subsystem 134 may be configured to use any one or more communication technology (e.g., wired or wireless communications) and associated protocols (e.g., Ethernet, Bluetooth®, Wi-Fi®, WiMAX, 3G, 4G LTE, etc.) to affect such communication.

The integrated device 138 may be embodied as a GPU, FPGA, ASIC, DSA, a coprocessor (such as a CPU, GPU, etc.), or other digital logic device capable of performing functions (e.g., accelerated application functions, accelerated network functions, or other accelerated functions), etc. The integrated device 138 may be coupled to the processor 120 via a high-speed connection interface such as a peripheral bus (e.g., a PCI Express bus) or an inter-processor interconnect (e.g., an in-die interconnect (IDI) or QuickPath Interconnect (QPI)), or via any other appropriate interconnect. The integrated device 138 may receive data and/or commands for processing from the processor 120 and return results data to the processor 120 via DMA, MMIO, or other data transfer transactions.

The integrated devices 138 may further include one or more peripheral devices. The peripheral devices may include any number of additional input/output devices, interface devices, hardware accelerators, and/or other peripheral devices. For example, in some embodiments, the peripheral devices may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

The computing device 100 may also include a network interface controller (NIC) 150. NIC 150 enables computing device 100 to communicate with another computing device 100 via a network. In embodiments, NIC 150 may comprise a programmable (or smart) NIC, infrastructure processing unit (IPU), or datacenter processing unit (DPU) that may be configured to perform different actions based on a type of packet, connection, or other packet characteristics.

In use, as described further below, a trusted execution environment (TEE) established by the processor 120 securely communicates data with the accelerator 136 and integrated devices 138. Data may be transferred using memory-mapped I/O (MMIO) transactions or direct memory access (DMA) transactions. For example, the TEE may perform an MMIO write transaction that includes encrypted data, and the accelerator device 136 and/or integrated devices 138 decrypt the data and perform the write. As another example, the TEE may perform an MMIO read request transaction, and the accelerator devices 136 and/or integrated devices 138 may read the requested data, encrypt the data, and perform an MMIO read response transaction that includes the encrypted data. As yet another example, the TEE may configure the accelerator devices 136 and/integrated devices 138 to perform a DMA operation, and the accelerator devices 136 and/or integrated devices 138 perform a memory transfer, performs a cryptographic operation (i.e., encryption or decryption), and forwards the result.

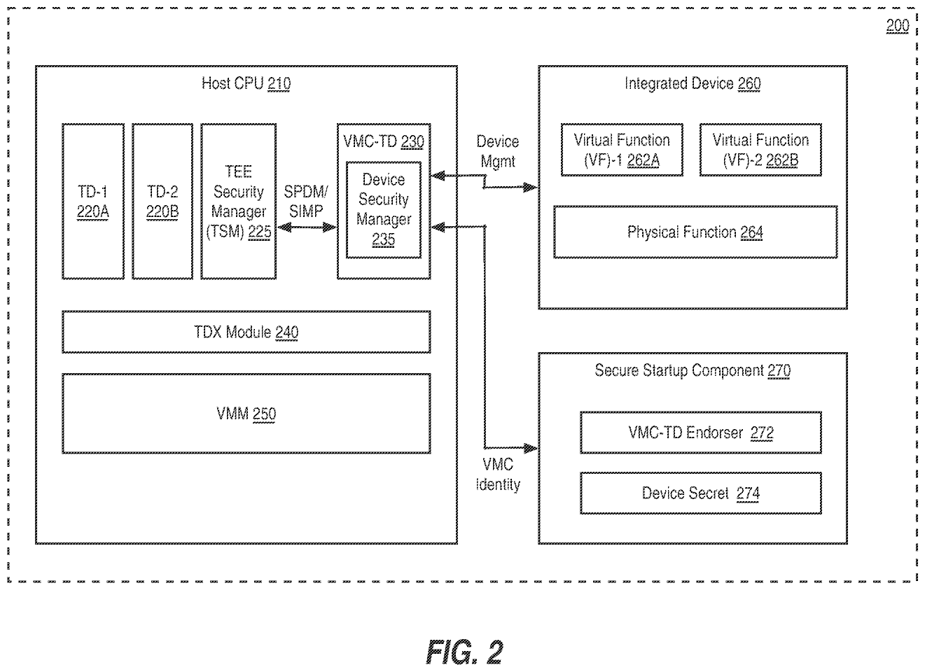

As described further below, the processor may provide a VMC-TD 121 for device authentication in the confidential computing environment provided in computing device 100. The VMC-TD 121 can be implemented as a service TD. The VMC-TD 121 provides a way to minimize actions of firmware during a hand-off to the OS, while allowing for a safe runtime interface to the OS from the firmware in order to safely and/or lazily initialize devices. Implementations of the disclosure provide for technical advantages of reducing the firmware trusted computing base (TCB) and allowing for an improved boot time (e.g., faster boot). Furthermore, implementations provide for minimizing the pre-OS footprint and implementing a trusted runtime adjunct to the OS. This can minimize the impact of the integrated device and add support for the TDX-IO architecture. Further details of the implementations and operation of VMC-TD 121 are provided below with respect to FIGS. 2-13.

Although implementations herein are discussed in terms of the TDX-IO architecture, implementations are not limited solely to such an architecture and other confidential computing protocols and architectures (e.g., AMD® SEV®, etc.) can utilize implementations herein.

Turning now to FIG. 2, an example confidential computing environment for providing a virtual microcontroller for device authentication in accordance with implementations herein is depicted.

FIG. 2 illustrates a computing environment 200 for providing a virtual microcontroller for device authentication in a confidential computing environment, in accordance with implementations herein. In one implementation, computing environment 200 may be the same as computing device 100 described with respect to FIG. 1. Computing environment 200 may include a host CPU 210, an integrated device 260, and a secure startup component 270. In implementations herein the host CPU 210 may implement a confidential computing environment via one or more TDs, including TD-1 220A and TD-2 220B (collectively referred to herein as TDs 220). TDs 220 may be hardware-isolated VMs, which are isolated from the VMM 250 (or hypervisor), as well as other non-TD software in the computing environment 200.

To help enforce security policies for the TDs 220, the host CPU 210 can operate in a mode called secure-arbitration mode (SEAM) that provides for a security-services model, the TDX module 240, that is hosted in a reserved memory space of the host CPU 210. In one embodiment, the reserved memory space may be identified by a SEAM-range register. The host CPU 210 may allow access to SEAM-memory range to software executing inside the SEAM-memory range. All other software accesses and DMA from devices to this memory range are aborted. The SEAM-memory range also offers cryptographic confidentiality protection with an ephemeral memory-encryption key. Memory integrity may also be enforced by either the cryptographic-integrity protection scheme or a logical-integrity protection scheme.

The TDX module 240 helps ensure that the execution controls active for a TD 220 do not allow the VMM 250 or other untrusted entities to intercept TD accesses to TD-assigned resource, like control registers, performance-monitoring counters, time stamp counters, etc. The TDX module 240 can implement security policies for the TDs 220. An example of such a security policy could be the TDX module 240 using the indirect-branch-prediction barrier (IBPB) when switching TDs 220 to help keep a TD-indirect-branch prediction from being influenced by code in a previously-executed TD 220.

As previously noted, the TDs 220 may seek to establish a trust relationship with one or more integrated devices 260 of the computing environment 200. The confidential computing architecture, such as the TDX architecture, supports TDX with device I/O, also known as TDX-IO. TDX-IO enables assigning a virtual function (VF), such as VF-1 262A or VF-2 262B (collectively referred to as VFs 262), of the integrated device 260 to a specific TD 220. The VFs 262 may be virtualized portions of the physical function 264 provided by integrated device 260. The VFs 262 can be lightweight functions that share one or more physical resources with the physical function 264 and with VFs 262 that are associated with that physical function 264. Unlike a physical function 264, a VF 262 can configure its own behavior.

More specifically, implementations herein provide for a virtual microcontroller trust domain (VMC-TD) 230 implemented as a service TD in host CPU 210. The VMC-TD 230 can host a device security manager 235 to support SPDM/TDISP protocols for the integrated device 260 to establish a trust relationship between the TDs 220 and the integrated device 260. The VMC-TD 230 may communicate with a TEE security manager (TSM) using the SPDM/TDISP protocols to coordinate with TDs 220 to establish the trusted relationship for TDX-IO. Implementations herein consider the following areas when utilizing the VMC-TD 230 to establish the trust relationship for confidential computing between TDs 220 and integrated device 260: device identity, device authentication, device measurement, virtual device management, and seamless update.

### Device Identity

The VMC-TD 230 does not include any persistent storage and it cannot hold any private keys to utilize for device identification. Instead, in implementations herein, the VMC-TD 230 can generate an alias private/public key pair at runtime, then ask a secure startup component 270 (such as a startup service module (S3M), or a quoting enclave (QE)) to sign the public alias certificate, which contains the alias public key. The secure startup component 270 includes a VMC-TD endorser 272 to provide endorser services. The secure startup component 270 acts as an endorser to sign the VMC-TD alias certificate and returns a certificate chain, where the root certificate is the secure startup component's 270 certificate. The secure startup component 270 may include a secure key storage area to store a device secret 274, such as a secure startup component 270 certificate signing key.

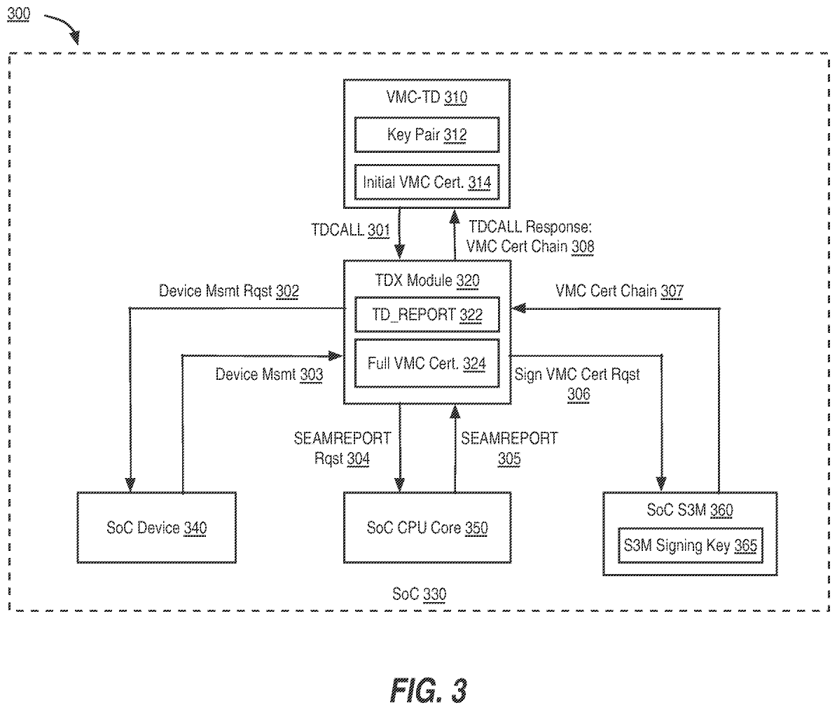

FIG. 3 illustrates a block diagram of confidential computing environment 300 for VMC-TD certificate generation, in accordance with implementations herein. In one implementation, confidential computing environment 300 may be part of computing device 100 of FIG. 1 and/or computing environment 200 of FIG. 2. Confidential computing environment 300 may include an SoC 330 that hosts VMV-TD 310, TDX module 320, SoC device 340, SOC CPU core 350, and SoC S3M 260. In one embodiment, VMC-TD 310 is the same as VMC-TD 230 of FIG. 2 and TDX module 320 is the same as TDX module 240 of FIG. 2. SOC device 340 may be the same as integrated device 260 of FIG. 2. SOC CPU core 350 may be the same as host CPU 210 of FIG. 2 and SoC S3M 360 may be the same as secure startup component 270 of FIG. 2.

Confidential computing environment 300 provides for VMC-TD certificate chain generation. In one example, the VMC-TD certificate chain generation can utilize a DSA as the SoC device 340 and S3M 360 as the startup service component.

The following discussion provides an example walk-through of a VMC-TD certificate chain generation process for device identity. In one embodiment, the VMC-TD 310 can generate a key pair 312 and then create an initial VMC certificate 314 with the public key from the key pair 312. The VMC-TD 310 can then invoke a generate certificate call 301, such as a TDCALL GenCertChain, using the initial VMC certificate 314.

The TDX module 320 can receive the generate certificate call 301 (e.g., TDCALL) from the VCM-TD 310. The TDX module 320 can then request 302 a device measurement from a hardware register of the SoC device 340. The SoC device 340 may return 303 the device measurement to the TDX module 320 in response to the request.

The TDX module 320 may then extract the public key from the initial VMC certificate 314 and create a hash of the public key. Then, the TDX module 320 can request 304 the SoC CPU core 350 to generate a SEAMREPORT using the VMC public key hash and the device measurement. The SEAMREPORT may refer to an evidence structure (e.g., a report) that is cryptographically bound to the platform hardware with a message authentication code (MAC). A SEAMREPORT instruction is designed to take the attestation information (e.g., VMC public key hash) provided by the VMC-TD 310, the TD measurements, and additional information provided by the TDX module 320 as input and generate a “Report” structure that includes the security version numbers (SVNs) of the TDX TCB elements. This “Report” structure is designed to be integrity-protected using a MAC (e.g., a SEAMREPORT MAC key). In some implementations, the SEAMREPORT can be utilized to help generate remote-attestation quotes.

The SoC CPU core 350 can generate and return 305 the SEAMREPORT to the TDX module 320. Once the SEAMRPORT is received, the TDX module 320 can create a TD_REPORT 322 based upon SEAMREPORT. The TD_REPORT 322 may refer to an attestation of a measurement of the TD (e.g., VMC-TD 310) and can include a structure that include the TD's measurement, the TDX module 320 measurements, and a value provided by the TD software (e.g., VMC-TD 310). In some implementations, the TD_REPORT 322 includes a VMC-TD 310 measurement register (e.g., TD MR) and a runtime measurement register (e.g., RTMR), which can be used to verify the integrity state of the VMC-TD 310. The TD_REPORT 322 can also include the device measurement of the SoC device 340, which can used to identify the SoC device 340.

The TDX module 320 can insert the TD_REPORT 322 along with the initial VMC certificate 314 to generate a full VMC certificate 324 having a TEE report OID (object identifier). Then, the TDX module 320 requests 306 the SoC S3M 360 or an individual QE to sign the full VMC certificate 324.

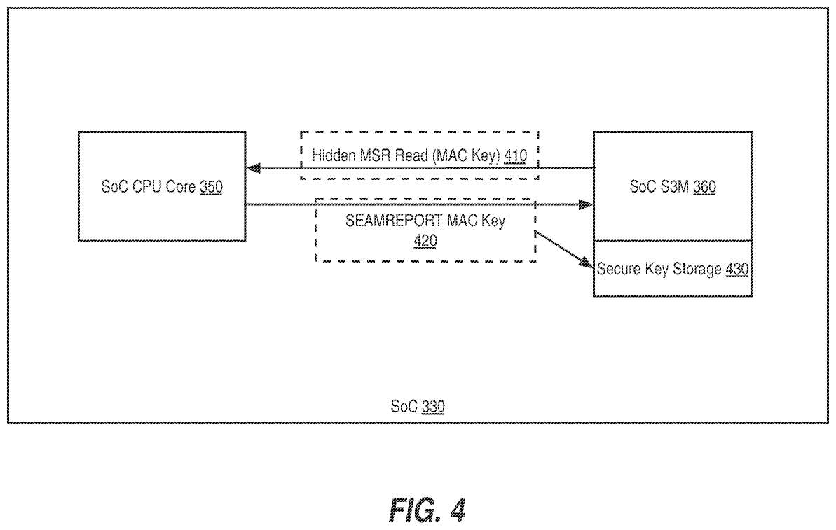

The SoC S3M 360 receives the request 306 to sign the full VMC certificate 324 from TDX module 320 and signs it with a S3M certificate signing key 365 maintained by the SoC S3M 360. In one implementation, the S3M certificate signing key 365 may refer to a SEAMREPORT MAC key (obtained from the SoC CPU core 350). Further details of this process are discussed below with respect to FIG. 4. The SoC S3M 360 returns 307 a full VMC certificate chain to the TDX module 320. The full VMC certificate chain includes the S3M root certificate, the S3M signing certificate, and the signed full VMC certificate (including the TD_REPORT). Lastly, the TDX module 320 returns 308 the full VMC certificate chain to the VMC-TD 310 in response to the generate certificate call (e.g., TDCALL) issued by the VMC-TD 310. The VMC-TD 310 can then utilize the full VMC certificate chain as the identity for the SoC device 340 when establishing a trusted relationship for communication with the SoC device 340. Besides SoC S3M, a quoting enclave (QE) could also be used to perform the signing as endorsement.

FIG. 4 illustrates the generation of the full VMC certificate chain by the SoC S3M 360 of FIG. 3, in accordance with implementations herein. In one implementation, SoC 330 of FIG. 3 is shown including SoC CPU core 350 and SoC S3M 360. As discussed above with respect to FIG. 3, steps 304 and 305 involve the TDX module 320 requests the SEAMREPORT from the CPU core 350, the SoC CPU core 350 generates the SEAMREPORT, and the SoC CPU core 350 returns 305 the SEAMREPORT to the TDX module 320. However, in some implementations, these steps (304 and 305) may not have to be performed when the SoC S3M 360 has an ability to obtain the MAC key from the SoC CPU core 350.

For example, the SoC S3M 360 can issue a hidden MSR read 410 to the SoC CPU core 350. The MSR may be controlled by a policy (e.g., an SAI policy) so that the SoC S3M 430 is allowed to read it. Once SoC S3M 430 obtains the SEAMREPORT MAC key 420, the key 420 can be stored in a secure key storage 430 area of the SoC S3M 360. The secure key storage 430 may store the key 420 using confidentiality protections along with other S3M keys, such as a device private key or root MAC key.

### Device Authentication

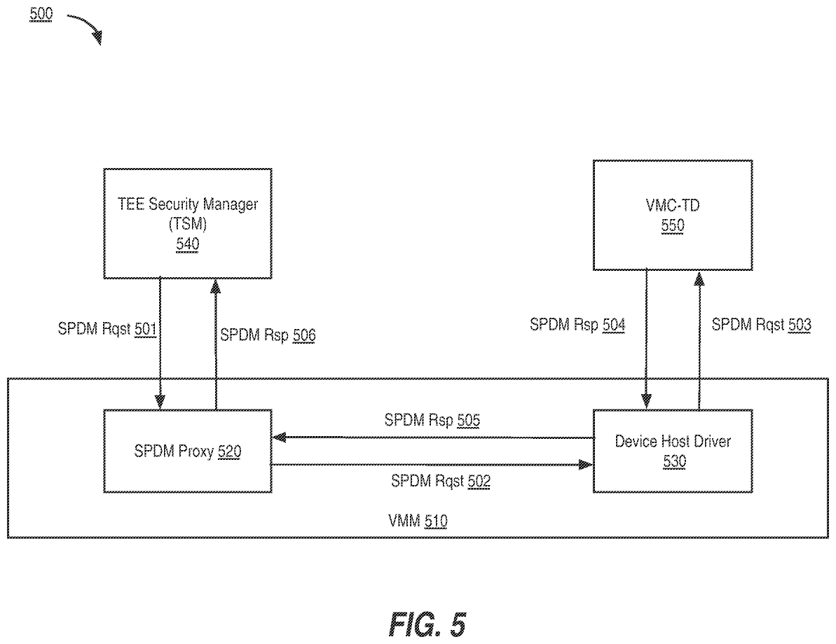

FIG. 5 illustrates a block diagram of confidential computing environment 500 for device authentication, in accordance with implementations herein. In one implementation, confidential computing environment 500 may be part of computing device 100 of FIG. 1 and/or computing environment 200 of FIG. 2. Confidential computing environment 500 may include a VMM 510 that hosts an SPDM proxy 520 and a device host driver 530. Confidential computing environment 500 may also include a TSM 540 and a VMC-TD 550. In one embodiment, VMM 510 is the same as VMM 250 of FIG. 2, VMC-TD 310 is the same as VMC-TD 230 of FIG. 2, and TSM 540 is the same as TSM 225 of FIG. 2.

Confidential computing environment 500 provides for device authentication of a device as part of establishing a trusted relationship for communication between TDs and the device in the confidential computing environment 500. In one example, the device authentication process can utilize a SPDM protocol to authenticate the device. However, other device authentication protocols may be utilized by implementations herein and are not solely limited to the SPDM protocol for device authentication. For ease of explanation, the following discussion of device authentication in the confidential computing environment 500 is described utilizing an SPDM protocol.

The TSM 540 issue an SPDM GET_CERTIFICATE command to obtain a device VMC-TD certificate chain. In one implementation, the device VMC-TD certificate chain is the same as the full VMC certificate chain generated as discussed in FIG. 3. If the TSM 540 seeks to authenticate a device, it can generate a nonce value and sends the SPDM command-CHALLENGE (nonce) to the device's VMC-TD 550. Then, the device's VMC-TD 510 signs the transcript message with its private key and returns a CHALLENGE_AUTH back the TSM 540. Subsequently, the TSM 540 may utilize the leaf certificate to verify the signature.

In implementations herein, in order to enable the TSM 540 to use the SPDM protocol to communicate with the VMC-TD 550 for purposes of device authentication, a device host driver 530 is implemented in the VMM 510. As the TSM cannot access the device directly and the VMM 510 owns the system resources, the TSM 540 can send a device SPDM request 501 to the VMM 510. The VMM 510 may implement an SPDM proxy 520, which can forward 502 the SPDM request to the device host driver 530, as the SPDM responder is the device.

The device host driver 530 then identifies the device VMC-TD 550 and injects 503 the SPDM request to the device VMC-TD 550. The VMC-TD 550 can process the SPDM request, generate an SPDM response, and send back 504 the SPDM response to the device host driver 530. For example, in some implementations, the VMC-TD 550 can use a virtio interface or a mailbox setup between the VMC-TD 550 and the device host driver 530 for this communication.

The device host driver 530 can then return 505 the SPDM response to the SPDM proxy 520 of the VMM 510. Lastly, the SPDM proxy 520 returns 506 the SPDM response to the TSM 540 for device authentication purposes.

### Device Measurement

With respect to FIG. 5, in implementations herein, the TSM 540 may also seek to obtain the device measurement of the device. The TSM 540 may also utilize the SPDM protocol for the device measurement process, as detailed below. There may be various techniques to obtain device measurements, with two such techniques are discussed below.

With respect to a first technique, in one implementation, the TSM 540 can use a SPDM GET_MEASUREMENTS command, sent to the device VMC-TD 550. Once the device VMC-TD 550 receives such a request, it can extract the TDMR and RTMR from the TD report, as well as a device measurement (such as ROM, firmware, hardware configuration, firmware configuration, device state, etc.), generate an SPDM measurement block, and return the SPDM measurement block.

With respect to a second technique, in one implementation, the TSM 540 parse the VMC-TD certificate and extract the TDMR and RTMR from the TD_REPORT, and device measurement directly.

### Virtual Device Measurement

After the device authentication and measurement processes are completed (e.g., via establishing the SPDM connection), the TSM may use a TDISP protocol to control the virtual functions (VFs) or interface of the device in the confidential computing environment (e.g., TDX architecture, etc.). For example, a virtual function 1 (VF-1) of the device can be assigned to a first TD (TD-1), the virtual function 2 (VF-2) of the device is assigned to a second TD (TD-2), and so on in the confidential computing environment.

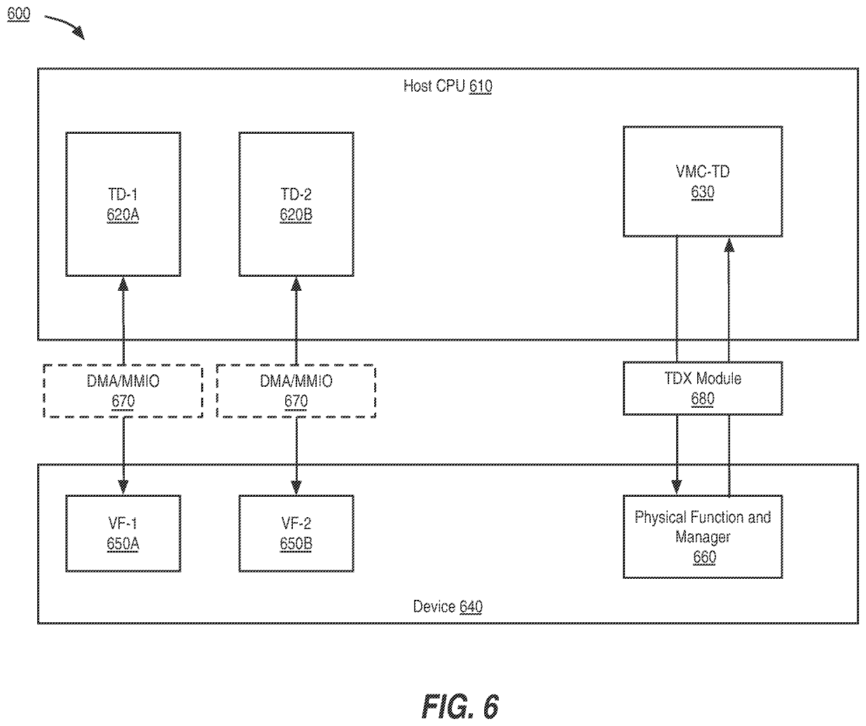

FIG. 6 illustrates a block diagram of confidential computing environment 600 for virtual device measurement and management, in accordance with implementations herein. In one implementation, confidential computing environment 600 may be part of computing device 100 of FIG. 1 and/or computing environment 200 of FIG. 2. Confidential computing environment 600 may include a host CPU 610 and a device 640. Host CPU 610 may host one or more TDs including TD-1 620A and TD-2 620B (collectively referred to herein as TDs 620) and a VMC-TD 630. Device 640 may include one or more virtual functions (VFs) including VF-1 650A and VF-2 650B (collectively referred to as VFs 650) and a physical function and manager 660. VFs 650 may be the virtualization of resources of physical function and manager 660.

Confidential computing environment 600 may also include a TDX module 680 used to communicably couple VMC-TD 630 and physical function and manager 660. In one embodiment, host CPU 610 is the same as host CPU 210 of FIG. 2, device 640 is the same as integrated device 260 of FIG. 2, TDs 620 are the same as TDs 220 of FIG. 2, VFs 650 are the same as VFs 262 of FIG. 2, physical function and manager 660 are the same as physical function 264 of FIG. 2, and TDX module 680 is the same as TDX module 240 of FIG. 2.

Confidential computing environment 600 provides for virtual device measurement and management as part of establishing a trusted relationship for communication between TDs 620 and the device 640 in the confidential computing environment 600. In one example, the device authentication process can utilize a TDISP protocol to manage VFs 650 of the device 640 and manage the device 640. However, other device authentication protocols may be utilized by implementations herein and are not solely limited to the TDISP protocol for management of the device's function(s). For ease of explanation, the following discussion of virtual device management in the confidential computing environment 600 is described utilizing a TDISP protocol.

In some implementations, the TSM (not shown) may issue a TDISP command to manage (e.g., assign, unassign, etc.) a VF 650 of a device 640 to a TD 620. Because the VMC-TD 630 is the one that receives the TDISP command, the VMC-TD 630 should be able to communicate with the physical function and manager 660 in the device 640. In some implementations, DMA or MMIO 670 may be utilized to communicate between the TDs 620 and the VFs 650. During platform boot-time configuration, a process initiated as part of the basic input output system (BIOS) is initiated to collect MMIO space. This process may be referred to as MCHECK in some implementations, but may be referred to with a different name or be a different process in other implementations. The MCHECK process may report the MMIO page address of the device 640 to TDX module 680.

In some implementations, the MMIO page address may accept those transactions with an integrity and data encryption (ide) value of ide_t=1. A transaction with ide_t=1 can be generated when an MMIO request is made with the TDX Key ID. As only a TD 620 can make access using the TDX key ID, this enforces that the VMC-TD 630 can access this MMIO page. The TDX module 680 can then map this MMIO page of the device 640 to the VMC-TD 630.

### Seamless Update

The VMC-TD of implementations herein should also support seamless update use cases. Seamless update refers to handling system during runtime of the firmware without taking down services provided by the firmware. Such firmware updates could be motivated by bug fixes, security fixes, or performance enhancements, for example.

With respect to VMC-TD and seamless updates, even if a device's VMC-TD is to be updated, the SPDM session shall be kept running. To support seamless update in implementations herein, the VMC-TD should save the SPDM session information (e.g., AEAD Key, AEAD IV, Session Sequence Number) as VMC-TD data (VMC-TD info).

Implementations herein provide for at least two options for seamless update of the VMC-TD. However, other seamless update options may be utilized by implementations herein and are not limited to those described herein.

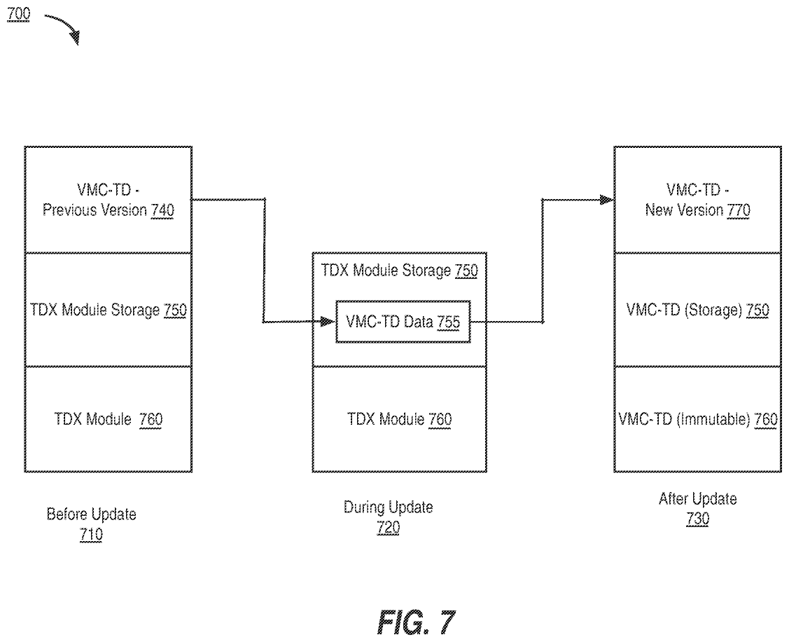

A first option for seamless update of the VMC-TD includes update of the entire (whole) VMC-TD. FIG. 7 is a block diagram illustrating a confidential computing environment 700 implementing seamless update of the entire VMC-TD, in accordance with implementations herein. Confidential computing environment 700 includes three phases of the seamless update process for the entire VMC-TD: before update 710, during update 720, and after update 730.

As part of the seamless update process of the entire VMC-TD, the VMM teardowns the old (previous) VMC-TD 740 and launches a new VMC-TD 770. As such, the whole VMC-TD is updatable. In the before update 710 phase, the previous VMC-TD 740 saves its VMC-TD data 755 to a TDX module storage area 750 before update 710 and restores the VMC-TD data 755 to the new VMC-TD 770 after update 730.

In some implementations, because the VMC-TD 740 is a special service TD, it can be bound with the TDX module 760. For example, a TDX module 760 may launch those VMC-TDs that are “known” to be good (verified and authenticated, trusted). In order to support that in VMC-TD 740 seamless update process, updates of both the TDX module and the VMC-TD may be made together. When the TDX module updates itself, it can guarantee the Secure Version Number (SVN) does not downgrade. The TDX module can also guarantee that the SVN of the new VMC-TD 770 does not downgrade.

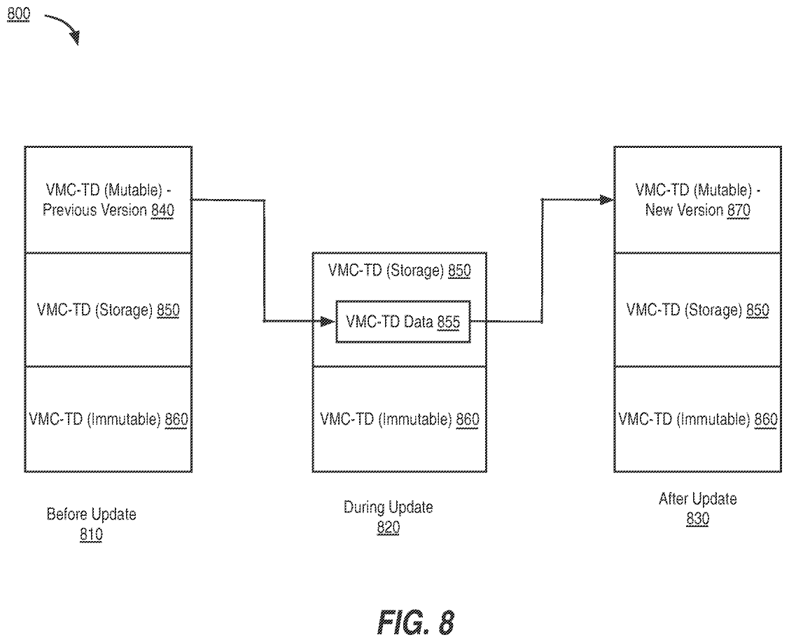

A second option for seamless update of the VMC-TD includes update of a portion, such as a mutable portion, of the VMC-TD. FIG. 8 is a block diagram illustrating a confidential computing environment 800 implementing seamless update of a portion (mutable portion) of a VMC-TD, in accordance with implementations herein. Confidential computing environment 800 includes three phases of the seamless update process for the portion of the VMC-TD: before update 810, during update 820, and after update 830.

If complete teardown and re-launching of the VMC-TD is not utilized, then implementations can allow the VMC-TD to accept an update payload. In one implementation, the VMC-TD is partitioned into an immutable portion 860, a storage area 850, and a mutable portion (previous version) 840. The immutable portion 860 of VMC-TD is treated as root-of-trust for update (RTU). The RTU is not updatable, while the mutable portion (previous version) 840 can be updated.

Before the update 810, the previous version of the mutable portion 840 of the VMC-TD should save the VMC-TD data 855 to the VMC-TD storage area 850. During the update 820, the previous version of the mutable portion 840 of the VMC-TD is torn down and updated. In some implementations, when the VMC-TD RTU performs the update 820, it should check the integrity of update payload via a digital signature and ensure the SVN is not downgraded. Then, the new version of the mutable portion 870 of the VMC-TD is restored with the VMC-TD data 855 after update 830.

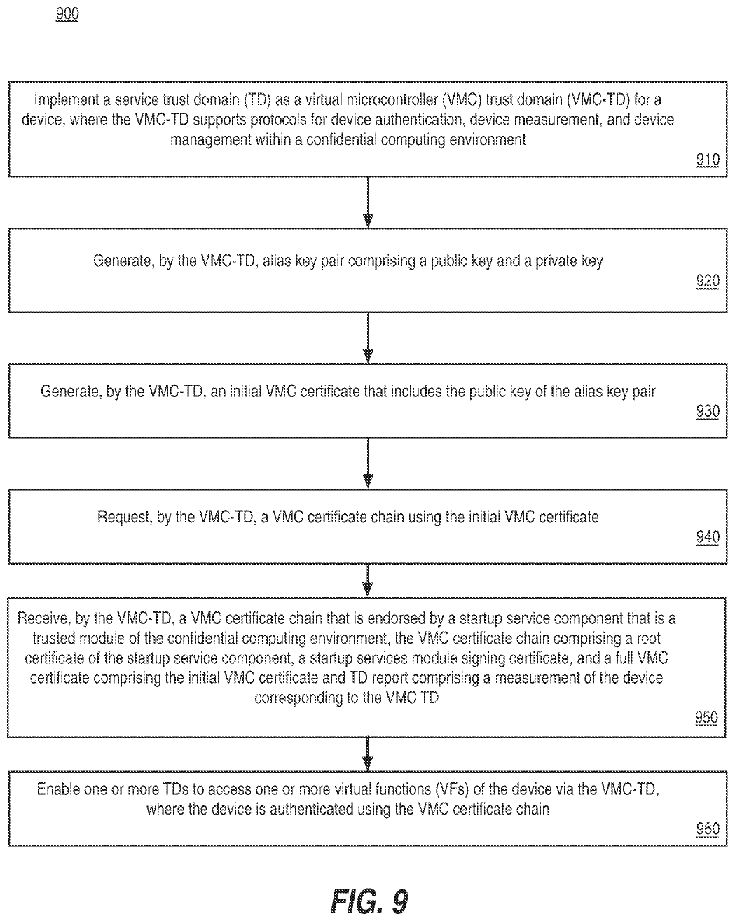

FIG. 9 is a flow diagram illustrating operations 900 for providing a virtual microcontroller for a device in a confidential computing environment, according to implementations of the disclosure. Some or all of the operations 900 (or other processes described herein, or variations, and/or combinations thereof) are performed under the control of one or more computer components configured to execute and are implemented as code (e.g., executable instructions, one or more computer programs, or one or more applications). The code is stored on a computer-readable storage medium, for example, in the form of a computer program comprising instructions executable by one or more processors. The computer-readable storage medium is non-transitory. In some embodiments, one or more (or all) of the operations 900 are performed by a processor (processing device, processor device, processor hardware circuitry, processing hardware circuitry, etc.), such as host CPU 210 of FIG. 2.

The operations 900 include, at block 910, where the processor may implement a service TD as a VMC-TD for a device. In one implementations, the VMC-TD can support protocols for device authentication, device measurement, and device management within a confidential computing environment. Such protocols can include, for example, an SPDM protocol and/or the TDISP protocol. At block 920, the processor may generate, by the VMC-TD, alias key pair comprising a public key and a private key.

Then, at block 930, the processor may generate, by the VMC-TD, an initial VMC certificate that includes the public key of the alias key pair. At block 940, the processor may request, by the VMC-TD, a VMC certificate chain using the initial VMC certificate.

Subsequently, at block 950, the processor may receive, by the VMC-TD, a VMC certificate chain that is endorsed by a startup service component that is a trusted module of the confidential computing environment. In one implementation, the VMC certificate chain includes a root certificate of the startup service component, a startup services module signing certificate, and a full VMC certificate comprising the initial VMC certificate and TD report comprising a measurement of the device corresponding to the VMC-TD. Lastly, at block 960, the processor may enable one or more TDs to access one or more VFs of the device via the VMC-TD, where the device is authenticated using the VMC certificate chain.

Some of the operations illustrated in FIG. 9 may be repeated, combined, modified or deleted where appropriate, and additional steps may also be added to the flow in various embodiments. Additionally, steps may be performed in any suitable order without departing from the scope of particular embodiments.

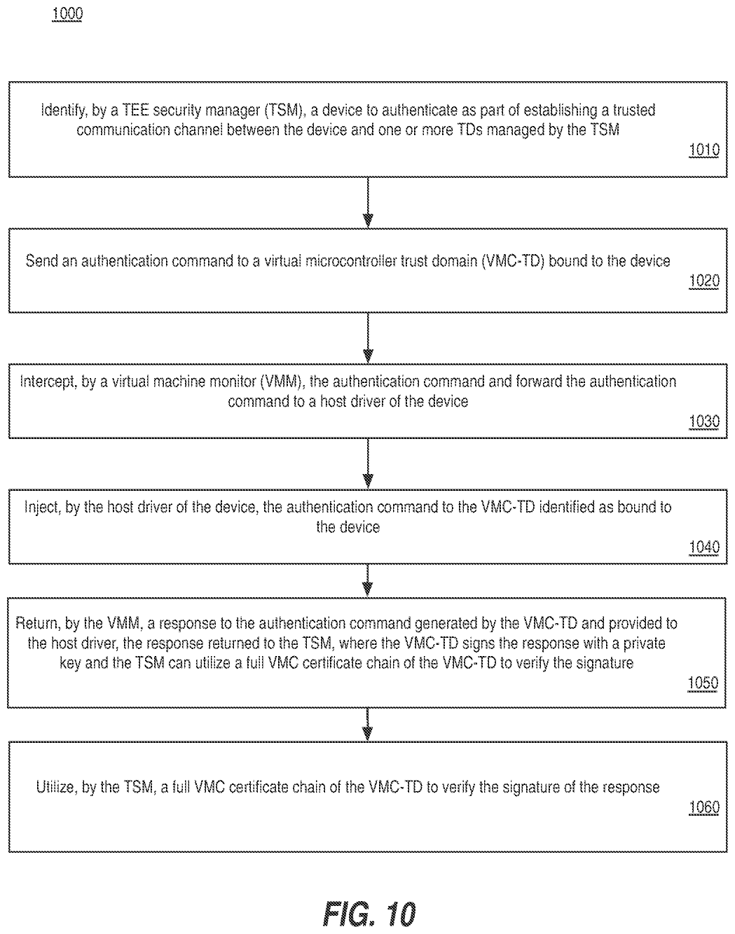

FIG. 10 is a flow diagram illustrating operations 1000 for providing a virtual microcontroller for device authentication in a confidential computing environment, according to implementations of the disclosure. Some or all of the operations 1000 (or other processes described herein, or variations, and/or combinations thereof) are performed under the control of one or more computer components configured to execute and are implemented as code (e.g., executable instructions, one or more computer programs, or one or more applications). The code is stored on a computer-readable storage medium, for example, in the form of a computer program comprising instructions executable by one or more processors. The computer-readable storage medium is non-transitory. In some embodiments, one or more (or all) of the operations 1000 are performed by a processor (processing device, processor device, processor hardware circuitry, processing hardware circuitry, etc.), such as host CPU 210 of FIG. 2.

The operations 1000 include, at block 1010, where the processor may identify, by a TSM, a device to authenticate as part of establishing a trusted communication channel between the device and one or more TDs managed by the TSM. Then, at block 1020, the processor may send an authentication command to a VMC-TD that is bound to the device.

At block 1030, the processor may intercept, by a VMM hosting the one or more TDs and the VMC-TD, the authentication command and forward the authentication command to a host driver of the device. Then, at block 1040, the processor may inject, by the host driver of the device, the authentication command to the VMC-TD identified as bound to the device.

Subsequently, at block 1050, the processor may return, by the VMM, a response to the authentication command generated by the VMC-TD and provided to the host driver. In one implementation, the response is returned to the TSM. The VMC-TD may then sign the response with a private key and the TSM can utilize a full VMC certificate chain of the VMC-TD to verify the signature. Lastly, at block 1060, the processor may utilize, by the TSM, a full VMC certificate chain of the VMC-TD to verify the signature of the response.

Some of the operations illustrated in FIG. 10 may be repeated, combined, modified or deleted where appropriate, and additional steps may also be added to the flow in various embodiments. Additionally, steps may be performed in any suitable order without departing from the scope of particular embodiments.

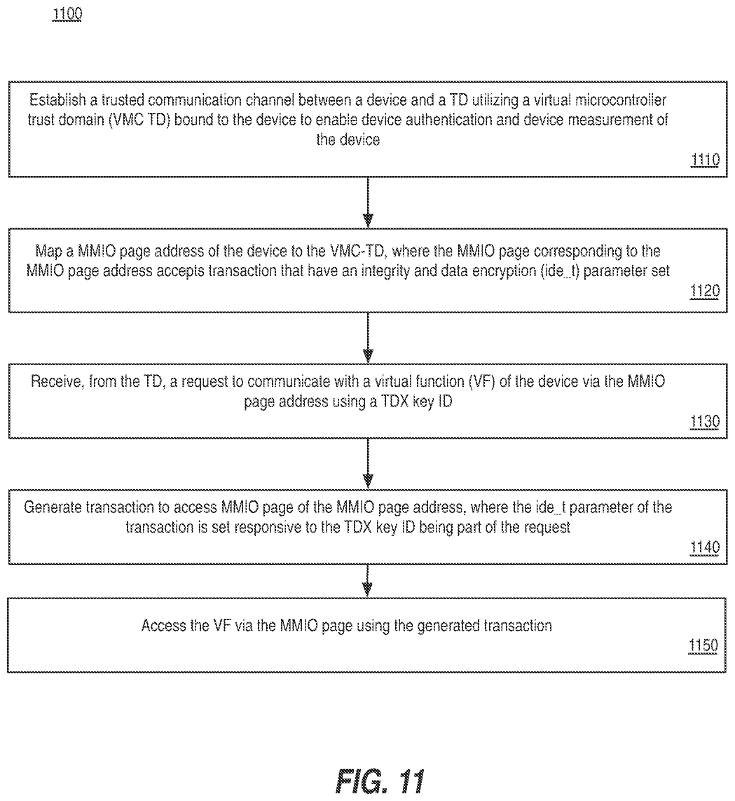

FIG. 11 is a flow diagram illustrating operations 1100 for providing a virtual microcontroller for device management in a confidential computing environment, according to implementations of the disclosure. Some or all of the operations 1100 (or other processes described herein, or variations, and/or combinations thereof) are performed under the control of one or more computer components configured to execute and are implemented as code (e.g., executable instructions, one or more computer programs, or one or more applications). The code is stored on a computer-readable storage medium, for example, in the form of a computer program comprising instructions executable by one or more processors. The computer-readable storage medium is non-transitory. In some embodiments, one or more (or all) of the operations 1100 are performed by a processor (processing device, processor device, processor hardware circuitry, processing hardware circuitry, etc.), such as host CPU 210 of FIG. 2.

The operations 1100 include, at block 1110, where the processor may establish a trusted communication channel between a device and a TD utilizing a VMC TD bound to the device to enable device authentication and device measurement of the device. Then, at block 1120, the processor may map a MMIO page address of the device to the VMC-TD. In one implementations, the MMIO page accepts transaction that have an integrity and data encryption (ide_t) parameter set.

Subsequently, at block 1130, the processor may receive, from the TD, a request to communicate with a virtual function (VF) of the device via the MMIO page address using a TDX key ID. At block 1140, the processor may generate transaction to access MMIO page of the MMIO page address. In one implementations, the ide_t parameter of the transaction is set responsive to the TDX key ID being part of the request. Lastly, at block 1150, the processor may access the VF via the MMIO page using the generated transaction.

Some of the operations illustrated in FIG. 11 may be repeated, combined, modified or deleted where appropriate, and additional steps may also be added to the flow in various embodiments. Additionally, steps may be performed in any suitable order without departing from the scope of particular embodiments.

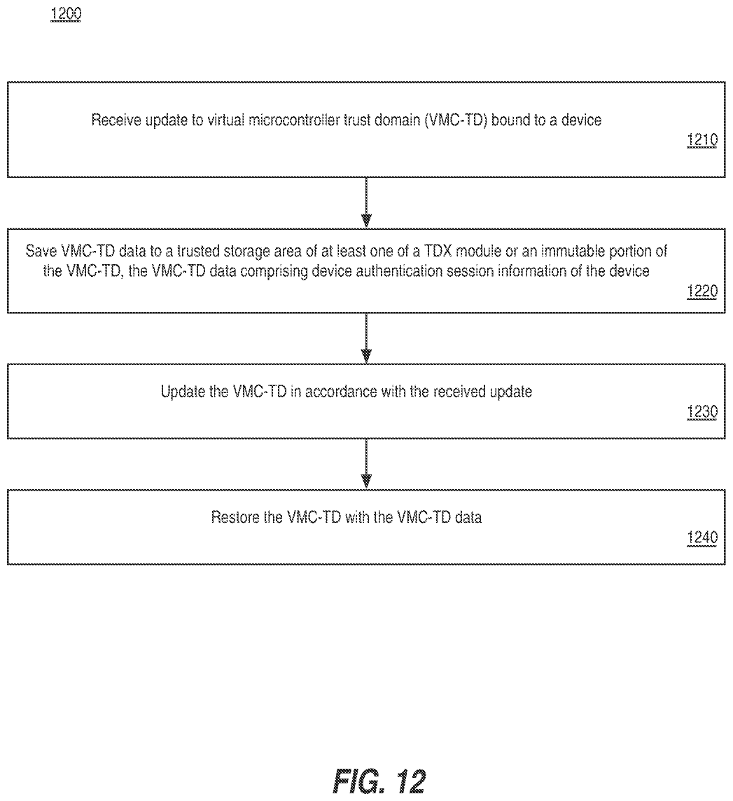

FIG. 12 is a flow diagram illustrating operations 1200 for providing seamless update for a virtual microcontroller of a device in a confidential computing environment, according to implementations of the disclosure. Some or all of the operations 1200 (or other processes described herein, or variations, and/or combinations thereof) are performed under the control of one or more computer components configured to execute and are implemented as code (e.g., executable instructions, one or more computer programs, or one or more applications). The code is stored on a computer-readable storage medium, for example, in the form of a computer program comprising instructions executable by one or more processors. The computer-readable storage medium is non-transitory. In some embodiments, one or more (or all) of the operations 1200 are performed by a processor (processing device, processor device, processor hardware circuitry, processing hardware circuitry, etc.), such as host CPU 210 of FIG. 2.

The operations 1200 include, at block 1210, where the processor may receive update to virtual microcontroller trust domain (VMC-TD) bound to a device. Then, at block 1220, the processor may save VMC-TD data to a trusted storage area of at least one of a TDX module or an immutable portion of the VMC-TD. In one implementation, the VMC-TD data includes device authentication session information of the device.

Subsequently, at block 1230, the processor may update the VMC-TD in accordance with the received update. Lastly, at block 1240, the processor may restore the VMC-TD with the VMC-TD data.

Some of the operations illustrated in FIG. 12 may be repeated, combined, modified or deleted where appropriate, and additional steps may also be added to the flow in various embodiments. Additionally, steps may be performed in any suitable order without departing from the scope of particular embodiments.

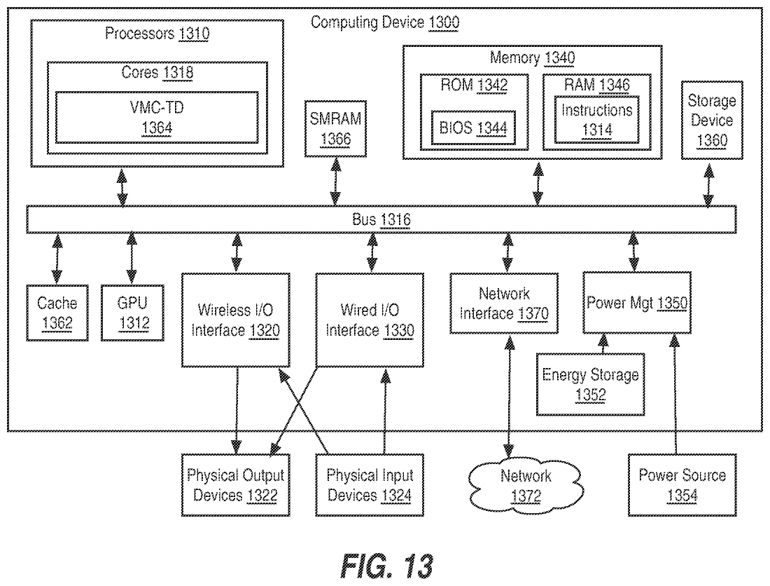

FIG. 13 is a schematic diagram of an illustrative electronic computing device to enable a virtual microcontroller for device authentication in a confidential computing environment, according to some implementations. In some implementations, the computing device 1300 includes one or more processors 1310 including one or more processors dies (e.g., cores) 1318 each including a VMC-TD 1364, such as VMC-TD 121 and/or VMC-TD 230 150 described with respect to FIGS. 1 and 2. In some embodiments, the computing device is to provide a virtual microcontroller for device authentication in a confidential computing environment using an VMC-TD component 1364, as provided in FIGS. 1-12.

The computing device 1300 may additionally include one or more of the following: cache 1362, a graphical processing unit (GPU) 1312 (which may be the hardware accelerator in some implementations), a wireless input/output (I/O) interface 1320, a wired I/O interface 1330, system memory 1340 (e.g., memory circuitry), power management circuitry 1350, non-transitory storage device 1360, and a network interface 1370 for connection to a network 1372. The following discussion provides a brief, general description of the components forming the illustrative computing device 1300. Example, non-limiting computing devices 1300 may include a desktop computing device, blade server device, workstation, or similar device or system.

In embodiments, the processor cores 1318 are capable of executing machine-readable instruction sets 1314, reading data and/or instruction sets 1314 from one or more storage devices 1360 and writing data to the one or more storage devices 1360. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 1318 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 1300 includes a bus or similar communications link 1316 that communicably couples and facilitates the exchange of information and/or data between various system components including the processor cores 1318, the cache 1362, the graphics processor circuitry 1312, one or more wireless I/O interfaces 1320, one or more wired I/O interfaces 1330, one or more storage devices 1360, and/or one or more network interfaces 1370. The computing device 1300 may be referred to in the singular herein, but this is not intended to limit the embodiments to a single computing device 1300, since in certain embodiments, there may be more than one computing device 1300 that incorporates, includes, or contains any number of communicably coupled, collocated, or remote networked circuits or devices.

The processor cores 1318 may include any number, type, or combination of currently available or future developed devices capable of executing machine-readable instruction sets.

The processor cores 1318 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 13 are of conventional design. Consequently, such blocks are not described in further detail herein, as they should be understood by those skilled in the relevant art. The bus 1316 that interconnects at least some of the components of the computing device 1300 may employ any currently available or future developed serial or parallel bus structures or architectures.

The system memory 1340 may include read-only memory (“ROM”) 1342 and random access memory (“RAM”) 1346. A portion of the ROM 1342 may be used to store or otherwise retain a basic input/output system (“BIOS”) 1344. The BIOS 1344 provides basic functionality to the computing device 1300, for example by causing the processor cores 1318 to load and/or execute one or more machine-readable instruction sets 1314. In embodiments, at least some of the one or more machine-readable instruction sets 1314 cause at least a portion of the processor cores 1318 to provide, create, produce, transition, and/or function as a dedicated, specific, and particular machine, for example a word processing machine, a digital image acquisition machine, a media playing machine, a gaming system, a communications device, a smartphone, or similar. The computing device may also include System Management RAM (SMRAM) 1366 for utilization as memory used by the processors 1310 to store code used with System Management Mode (SMM).

The computing device 1300 may include at least one wireless input/output (I/O) interface 1320. The at least one wireless I/O interface 1320 may be communicably coupled to one or more physical output devices 1322 (tactile devices, video displays, audio output devices, hardcopy output devices, etc.). The at least one wireless I/O interface 1320 may communicably couple to one or more physical input devices 1324 (pointing devices, touchscreens, keyboards, tactile devices, etc.). The at least one wireless I/O interface 1320 may include any currently available or future developed wireless I/O interface. Example wireless I/O interfaces include, but are not limited to: BLUETOOTH®, near field communication (NFC), and similar.

The computing device 1300 may include one or more wired input/output (I/O) interfaces 1330. The at least one wired I/O interface 1330 may be communicably coupled to one or more physical output devices 1322 (tactile devices, video displays, audio output devices, hardcopy output devices, etc.). The at least one wired I/O interface 1330 may be communicably coupled to one or more physical input devices 1324 (pointing devices, touchscreens, keyboards, tactile devices, etc.). The wired I/O interface 1330 may include any currently available or future developed I/O interface. Example wired I/O interfaces include, but are not limited to, universal serial bus (USB), IEEE 1394 (“FireWire”), and similar.

The computing device 1300 may include one or more communicably coupled, non-transitory, data storage devices 1360. The data storage devices 1360 may include one or more hard disk drives (HDDs) and/or one or more solid-state storage devices (SSDs). The one or more data storage devices 1360 may include any current or future developed storage appliances, network storage devices, and/or systems. Non-limiting examples of such data storage devices 1360 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 1360 may include one or more removable storage devices, such as one or more flash drives, flash memories, flash storage units, or similar appliances or devices capable of communicable coupling to and decoupling from the computing device 1300.

The one or more data storage devices 1360 may include interfaces or controllers (not shown) communicatively coupling the respective storage device or system to the bus 1316. The one or more data storage devices 1360 may store, retain, or otherwise contain machine-readable instruction sets, data structures, program modules, data stores, databases, logical structures, and/or other data useful to the processor cores 1318 and/or graphics processor circuitry 1312 and/or one or more applications executed on or by the processor cores 1318 and/or graphics processor circuitry 1312. In some instances, one or more data storage devices 1360 may be communicably coupled to the processor cores 1318, for example via the bus 1316 or via one or more wired communications interfaces 1330 (e.g., Universal Serial Bus or USB); one or more wireless communications interfaces 1320 (e.g., Bluetooth®, Near Field Communication or NFC); and/or one or more network interfaces 1370 (IEEE 802.3 or Ethernet, IEEE 802.11, or Wi-Fi®, etc.).

Processor-readable instruction sets 1314 and other programs, applications, logic sets, and/or modules may be stored in whole or in part in the system memory 1340. Such instruction sets 1314 may be transferred, in whole or in part, from the one or more data storage devices 1360. The instruction sets 1314 may be loaded, stored, or otherwise retained in system memory 1340, in whole or in part, during execution by the processor cores 1318 and/or graphics processor circuitry 1312.

The computing device 1300 may include power management circuitry 1350 that controls one or more operational aspects of the energy storage device 1352. In embodiments, the energy storage device 1352 may include one or more primary (i.e., non-rechargeable) or secondary (i.e., rechargeable) batteries or similar energy storage devices. In embodiments, the energy storage device 1352 may include one or more supercapacitors or ultracapacitors. In embodiments, the power management circuitry 1350 may alter, adjust, or control the flow of energy from an external power source 1354 to the energy storage device 1352 and/or to the computing device 1300. The power source 1354 may include, but is not limited to, a solar power system, a commercial electric grid, a portable generator, an external energy storage device, or any combination thereof.

For convenience, the processor cores 1318, the graphics processor circuitry 1312, the wireless I/O interface 1320, the wired I/O interface 1330, the storage device 1360, and the network interface 1370 are illustrated as communicatively coupled to each other via the bus 1316, thereby providing connectivity between the above-described components. In alternative embodiments, the above-described components may be communicatively coupled in a different manner than illustrated in FIG. 13. For example, one or more of the above-described components may be directly coupled to other components, or may be coupled to each other, via one or more intermediary components (not shown). In another example, one or more of the above-described components may be integrated into the processor cores 1318 and/or the graphics processor circuitry 1312. In some embodiments, all or a portion of the bus 1316 may be omitted and the components are coupled directly to each other using suitable wired or wireless connections.

The following examples pertain to further embodiments. Example 1 is a processing system to facilitate a virtual microcontroller for device authentication in a confidential computing environment. The processing system of Example 1 comprises one or more processors to: implement a service trust domain (TD) as a virtual microcontroller (VMC) trust domain (VMC-TD) for a device, where the VMC-TD is to support protocols for device authentication, device measurement, and device management within a confidential computing environment; and receive, by the VMC-TD, a VMC certificate chain that is endorsed by a startup service component comprising at least one of a trusted module of the confidential computing environment, the VMC certificate chain comprising a root certificate of the startup service component, a startup services module signing certificate, and a full VMC certificate comprising the initial VMC certificate and a TD report comprising a measurement of the device corresponding to the VMC TD.

In Example 2, the subject matter of Example 1 can optionally include wherein the one or more processors are further to generate, by the VMC-TD, an alias key pair comprising a public key and a private key; request, by the VMC-TD, the VMC certificate chain using an initial VMC certificate that comprises the public key of the alias key pair; and establish a secure communication channel between a trusted execution environment (TEE) security manager (TSM) of the confidential computing environment and the VMC-TD by utilizing the VMC certificate chain. In Example 3, the subject matter of any one of Examples 1-2 can optionally include wherein the one or more processors are further to enable one or more TDs to access one or more virtual functions (VFs) of the device via the VMC-TD, and wherein the device is authenticated using the VMC certificate chain.

In Example 4, the subject matter of any one of Examples 1-3 can optionally include wherein to authenticate the device, the TSM is to communicate a challenge to a device host driver executing in a virtual machine monitor (VMM) hosting the one or more TDs, wherein the device host driver to communicate with the device to enable the device to send a response to the challenge back to the TSM, and wherein the response to the challenge to authenticate the device is generated by the VMC-TD utilizing the private key of the alias key pair.

In Example 5, the subject matter of any one of Examples 1-4 can optionally include wherein the TSM is to: parse the full VMC certificate to obtain the TD report; extract a VMC-TD measurement register (TDMR), a runtime measurement (RTMR) from the TD report, and the measurement of the device from at least one of the TD report or the VMC certificate; utilize the measurement of the device to identify the device; and utilize the TDMR and the RTMR to verify an integrity state of the VMC-TD.

In Example 6, the subject matter of any one of Examples 1-5 can optionally include wherein the TSM is to: issue a command to obtain measurements from the VMC-TD; and receive from the VMC-TD, a measurement block comprising a VMC-TD measurement register (TDMR), a runtime measurement (RTMR), and the measurement of the device from the VMC-TD, wherein the TDMR, the RTMR, and the measurement of the device are extracted from at least one of the TD report or the VMC certificate by the VMC-TD.

In Example 7, the subject matter of any one of Examples 1-6 can optionally include wherein subsequent to establishment of the secure communication channel, the TSM is to control the one or more VFs via communication with the VMC-TD using the protocol for device management, and wherein the VMC-TD utilizes memory-mapped I/O (MMIO) to communicate with a physical function and device manager of the device to enable the control of the one or more VFs, or utilizes MMIO to obtain the device measurement from hardware register. In Example 8, the subject matter of any one of Examples 1-7 can optionally include wherein the MMIO is to accept transactions with an integrity and data encryption (ide) value that is set, and wherein the transactions with the ide value set are generated with a TD key identifier (ID) that the one or more TDs are provisioned.

In Example 9, the subject matter of any one of Examples 1-8 can optionally include wherein responsive to an entirety of the VMC-TD being updatable, the VMC-TD is to save VMC-TD data to a secure storage area of a TD extension (TDX) module and restore the VMC-TD data to the VMC-TD after a seamless update of the VMC-TD, the TDX module comprises a security services module of the confidential computing environment that ensures that execution controls active for the one or more TDs do not allow untrusted entities to intercept TD accesses to TD-assigned resources. In Example 10, the subject matter of any one of Examples 1-9 can optionally include wherein responsive to a mutable portion of the VMC-TD being updatable, the VMC-TD is to save VMC-TD data to a secure storage area of an immutable portion of the VMC-TD and restore the VMC-TD data to the VMC-TD after a seamless update of the VMC-TD.

Example 11 is a method for facilitating a virtual microcontroller for device authentication in a confidential computing environment. The method of Example 11 can include implementing, by one or more processors, a service trust domain (TD) as a virtual microcontroller (VMC) trust domain (VMC-TD) for a device, where the VMC-TD is to support protocols for device authentication, device measurement, and device management within a confidential computing environment; and receiving, by the VMC-TD, a VMC certificate chain that is endorsed by a startup service component comprising at least one of a trusted module of the confidential computing environment, the VMC certificate chain comprising a root certificate of the startup service component, a startup services module signing certificate, and a full VMC certificate comprising the initial VMC certificate and a TD report comprising a measurement of the device corresponding to the VMC TD.

In Example 12, the subject matter of Example 11 can optionally include wherein the one or more processors are further to: generate, by the VMC-TD, an alias key pair comprising a public key and a private key; request, by the VMC-TD, the VMC certificate chain using an initial VMC certificate that comprises the public key of the alias key pair; establish a secure communication channel between a trusted execution environment (TEE) security manager (TSM) of the confidential computing environment and the VMC-TD by utilizing the VMC certificate chain; and enable one or more TDs to access one or more virtual functions (VFs) of the device via the VMC-TD; wherein the device is authenticated using the VMC certificate chain. In Example 13, the subject matter of Examples 11-12 can optionally include wherein to authenticate the device, the TSM is to communicate a challenge to a device host driver executing in a virtual machine monitor (VMM) hosting the one or more TDs, wherein the device host driver to communicate with the device to enable the device to send a response to the challenge back to the TSM, and wherein the response to the challenge to authenticate the device is generated by the VMC-TD utilizing the private key of the alias key pair.

In Example 14, the subject matter of Examples 11-13 can optionally include wherein the TSM is to: parse the full VMC certificate to obtain the TD report; extract a VMC-TD measurement register (TDMR), a runtime measurement (RTMR) from the TD report, and the measurement of the device from at least one of the TD report or the VMC certificate; utilize the measurement of the device to identify the device; and utilize the TDMR and the RTMR to verify an integrity state of the VMC-TD.

In Example 15, the subject matter of Examples 11-14 can optionally include wherein the TSM is to: issue a command to obtain measurements from the VMC-TD; and receive from the VMC-TD, a measurement block comprising a VMC-TD measurement register (TDMR), a runtime measurement (RTMR), and the measurement of the device from the VMC-TD, wherein the TDMR, the RTMR, and the measurement of the device are extracted from at least one of the TD report or the VMC certificate by the VMC-TD.

In Example 16, the subject matter of Examples 11-15 can optionally include wherein responsive to an entirety of the VMC-TD being updatable, the VMC-TD is to save VMC-TD data to a secure storage area of a TD extension (TDX) module and restore the VMC-TD data to the VMC-TD after a seamless update of the VMC-TD, the TDX module comprises a security services module of the confidential computing environment that ensures that execution controls active for the one or more TDs do not allow untrusted entities to intercept TD accesses to TD-assigned resources.

Example 17 is a non-transitory computer-readable storage medium for facilitating a virtual microcontroller for device authentication in a confidential computing environment. The non-transitory computer-readable storage medium of Example 17 having stored thereon executable computer program instructions that, when executed by one or more processors, cause the one or more processors to perform operations comprising: implementing, by the one or more processors, a service trust domain (TD) as a virtual microcontroller (VMC) trust domain (VMC-TD) for a device, where the VMC-TD is to support protocols for device authentication, device measurement, and device management within a confidential computing environment; and receiving, by the VMC-TD, a VMC certificate chain that is endorsed by a startup service component comprising a trusted module of the confidential computing environment, the VMC certificate chain comprising at least one of a root certificate of the startup service component, a startup services module signing certificate, and a full VMC certificate comprising the initial VMC certificate and a TD report comprising a measurement of the device corresponding to the VMC TD.

In Example 18, the subject matter of Example 17 can optionally include generating, by the VMC-TD, an alias key pair comprising a public key and a private key; requesting, by the VMC-TD, the VMC certificate chain using an initial VMC certificate that comprises the public key of the alias key pair; establishing a secure communication channel between a trusted execution environment (TEE) security manager (TSM) of the confidential computing environment and the VMC-TD by utilizing the VMC certificate chain; and enabling one or more TDs to access one or more virtual functions (VFs) of the device via the VMC-TD; wherein the device is authenticated using the VMC certificate chain.

In Example 19, the subject matter of Examples 17-18 can optionally include wherein to authenticate the device, the TSM is to communicate a challenge to a device host driver executing in a virtual machine monitor (VMM) hosting the one or more TDs, wherein the device host driver to communicate with the device to enable the device to send a response to the challenge back to the TSM, and wherein the response to the challenge to authenticate the device is generated by the VMC-TD utilizing the private key of the alias key pair.

In Example 20, the subject matter of Examples 17-19 can optionally include wherein the TSM is to: parse the full VMC certificate to obtain the TD report; extract a VMC-TD measurement register (TDMR), a runtime measurement (RTMR) from the TD report, and the measurement of the device from at least one of the TD report of the VMC certificate; utilize the measurement of the device to identify the device; and utilize the TDMR and the RTMR to verify an integrity state of the VMC-TD.

Example 21 is a system for facilitating a virtual microcontroller for device authentication in a confidential computing environment. The system of Example 21 can optionally include a memory to store a block of data, and a processor communicably coupled to the memory to: implement a service trust domain (TD) as a virtual microcontroller (VMC) trust domain (VMC-TD) for a device, where the VMC-TD is to support protocols for device authentication, device measurement, and device management within a confidential computing environment; and receive, by the VMC-TD, a VMC certificate chain that is endorsed by a startup service component comprising at least one of a trusted module of the confidential computing environment, the VMC certificate chain comprising a root certificate of the startup service component, a startup services module signing certificate, and a full VMC certificate comprising the initial VMC certificate and a TD report comprising a measurement of the device corresponding to the VMC TD.

In Example 22, the subject matter of Example 21 can optionally include wherein the one or more processors are further to generate, by the VMC-TD, an alias key pair comprising a public key and a private key; request, by the VMC-TD, the VMC certificate chain using an initial VMC certificate that comprises the public key of the alias key pair; and establish a secure communication channel between a trusted execution environment (TEE) security manager (TSM) of the confidential computing environment and the VMC-TD by utilizing the VMC certificate chain. In Example 23, the subject matter of any one of Examples 21-22 can optionally include wherein the one or more processors are further to enable one or more TDs to access one or more virtual functions (VFs) of the device via the VMC-TD, and wherein the device is authenticated using the VMC certificate chain.

In Example 24, the subject matter of any one of Examples 21-23 can optionally include wherein to authenticate the device, the TSM is to communicate a challenge to a device host driver executing in a virtual machine monitor (VMM) hosting the one or more TDs, wherein the device host driver to communicate with the device to enable the device to send a response to the challenge back to the TSM, and wherein the response to the challenge to authenticate the device is generated by the VMC-TD utilizing the private key of the alias key pair.

In Example 25, the subject matter of any one of Examples 21-24 can optionally include wherein the TSM is to: parse the full VMC certificate to obtain the TD report; extract a VMC-TD measurement register (TDMR), a runtime measurement (RTMR) from the TD report, and the measurement of the device from at least one of the TD report or the VMC certificate; utilize the measurement of the device to identify the device; and utilize the TDMR and the RTMR to verify an integrity state of the VMC-TD.

In Example 26, the subject matter of any one of Examples 21-25 can optionally include wherein the TSM is to: issue a command to obtain measurements from the VMC-TD; and receive from the VMC-TD, a measurement block comprising a VMC-TD measurement register (TDMR), a runtime measurement (RTMR), and the measurement of the device from the VMC-TD, wherein the TDMR, the RTMR, and the measurement of the device are extracted from at least one of the TD report or the VMC certificate by the VMC-TD.

In Example 27, the subject matter of any one of Examples 21-26 can optionally include wherein subsequent to establishment of the secure communication channel, the TSM is to control the one or more VFs via communication with the VMC-TD using the protocol for device management, and wherein the VMC-TD utilizes memory-mapped I/O (MMIO) to communicate with a physical function and device manager of the device to enable the control of the one or more VFs, or utilizes MMIO to obtain the device measurement from hardware register. In Example 28, the subject matter of any one of Examples 21-27 can optionally include wherein the MMIO is to accept transactions with an integrity and data encryption (ide) value that is set, and wherein the transactions with the ide value set are generated with a TD key identifier (ID) that the one or more TDs are provisioned.

In Example 29, the subject matter of any one of Examples 21-28 can optionally include wherein responsive to an entirety of the VMC-TD being updatable, the VMC-TD is to save VMC-TD data to a secure storage area of a TD extension (TDX) module and restore the VMC-TD data to the VMC-TD after a seamless update of the VMC-TD, the TDX module comprises a security services module of the confidential computing environment that ensures that execution controls active for the one or more TDs do not allow untrusted entities to intercept TD accesses to TD-assigned resources. In Example 30, the subject matter of any one of Examples 21-29 can optionally include wherein responsive to a mutable portion of the VMC-TD being updatable, the VMC-TD is to save VMC-TD data to a secure storage area of an immutable portion of the VMC-TD and restore the VMC-TD data to the VMC-TD after a seamless update of the VMC-TD.

Example 31 is an apparatus for facilitating a virtual microcontroller for device authentication in a confidential computing environment, comprising means for implementing a service trust domain (TD) as a virtual microcontroller (VMC) trust domain (VMC-TD) for a device, where the VMC-TD is to support protocols for device authentication, device measurement, and device management within a confidential computing environment; and means for receiving, using the VMC-TD, a VMC certificate chain that is endorsed by a startup service component comprising a trusted module of the confidential computing environment, the VMC certificate chain comprising at least one of a root certificate of the startup service component, a startup services module signing certificate, and a full VMC certificate comprising the initial VMC certificate and a TD report comprising a measurement of the device corresponding to the VMC TD. In Example 32, the subject matter of Example 31 can optionally include the apparatus further configured to perform the method of any one of the Examples 12 to 16.

Example 33 is at least one machine readable medium comprising a plurality of instructions that in response to being executed on a computing device, cause the computing device to carry out a method according to any one of Examples 11-16. Example 34 is an apparatus for facilitating a virtual microcontroller for device authentication in a confidential computing environment, configured to perform the method of any one of Examples 11-16. Example 35 is an apparatus for facilitating a virtual microcontroller for device authentication in a confidential computing environment, comprising means for performing the method of any one of Examples 11-16. Specifics in the Examples may be used anywhere in one or more embodiments.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium (e.g., non-transitory computer-readable storage medium) having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments. The various appearances of “an embodiment,” “one embodiment,” or “some embodiments” are not all referring to the same embodiments. It should be appreciated that in the foregoing description of example embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments utilize more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

What is claimed is:

1. A processing system comprising:
one or more processors to:
implement a service trust domain (TD) as a virtual microcontroller (VMC) trust domain (VMC-TD) for a device, where the VMC-TD is to support protocols for device authentication, device measurement, and device management within a confidential computing environment; and
receive, by the VMC-TD, a VMC certificate chain that is endorsed by a startup service component comprising a trusted module of the confidential computing environment, the VMC certificate chain comprising at least one of a root certificate of the startup service component, a startup services module signing certificate, and a full VMC certificate comprising the initial VMC certificate and a TD report comprising a measurement of the device corresponding to the VMC TD.

2. The processing system of claim 1, wherein the one or more processors are further to:
generate, by the VMC-TD, an alias key pair comprising a public key and a private key;
request, by the VMC-TD, the VMC certificate chain using an initial VMC certificate that comprises the public key of the alias key pair; and
establish a secure communication channel between a trusted execution environment (TEE) security manager (TSM) of the confidential computing environment and the VMC-TD by utilizing the VMC certificate chain.

3. The processing system of claim 2, wherein the one or more processors are further to enable one or more TDs to access one or more virtual functions (VFs) of the device via the VMC-TD, and wherein the device is authenticated using the VMC certificate chain.

4. The processing system of claim 3, wherein to authenticate the device, the TSM is to communicate a challenge to a device host driver executing in a virtual machine monitor (VMM) hosting the one or more TDs, wherein the device host driver to communicate with the device to enable the device to send a response to the challenge back to the TSM, and wherein the response to the challenge to authenticate the device is generated by the VMC-TD utilizing the private key of the alias key pair.

5. The processing system of claim 3, wherein the TSM is to:
parse the full VMC certificate to obtain the TD report;
extract a VMC-TD measurement register (TDMR), a runtime measurement (RTMR) from the TD report, and the measurement of the device from at least one of the TD report or the VMC certificate;
utilize the measurement of the device to identify the device; and
utilize the TDMR and the RTMR to verify an integrity state of the VMC-TD.

6. The processing system of claim 3, wherein the TSM is to:
issue a command to obtain measurements from the VMC-TD; and
receive from the VMC-TD, a measurement block comprising a VMC-TD measurement register (TDMR), a runtime measurement (RTMR), and the measurement of the device from the VMC-TD, wherein the TDMR, the RTMR, and the measurement of the device are extracted from at least one of the TD report or the VMC certificate by the VMC-TD.

7. The processing system of claim 3, wherein subsequent to establishment of the secure communication channel, the TSM is to control the one or more VFs via communication with the VMC-TD using the protocol for device management, and wherein the VMC-TD utilizes memory-mapped I/O (MMIO) to communicate with a physical function and device manager of the device to enable the control of the one or more VFs, or utilizes MMIO to obtain the device measurement from hardware register.

8. The processing system of claim 7, wherein the MMIO is to accept transactions with an integrity and data encryption (ide) value that is set, and wherein the transactions with the ide value set are generated with a TD key identifier (ID) that the one or more TDs are provisioned.

9. The processing system of claim 1, wherein responsive to an entirety of the VMC-TD being updatable, the VMC-TD is to save VMC-TD data to a secure storage area of a TD extension (TDX) module and restore the VMC-TD data to the VMC-TD after a seamless update of the VMC-TD, the TDX module comprises a security services module of the confidential computing environment that ensures that execution controls active for the one or more TDs do not allow untrusted entities to intercept TD accesses to TD-assigned resources.

10. The processing system of claim 1, wherein responsive to a mutable portion of the VMC-TD being updatable, the VMC-TD is to save VMC-TD data to a secure storage area of an immutable portion of the VMC-TD and restore the VMC-TD data to the VMC-TD after a seamless update of the VMC-TD.

11. A method comprising:
implementing, by one or more processors, a service trust domain (TD) as a virtual microcontroller (VMC) trust domain (VMC-TD) for a device, where the VMC-TD is to support protocols for device authentication, device measurement, and device management within a confidential computing environment; and
receiving, by the VMC-TD, a VMC certificate chain that is endorsed by a startup service component comprising at least one of a trusted module of the confidential computing environment, the VMC certificate chain comprising a root certificate of the startup service component, a startup services module signing certificate, and a full VMC certificate comprising the initial VMC certificate and a TD report comprising a measurement of the device corresponding to the VMC TD.

12. The method of claim 11, wherein the one or more processors are further to:
generate, by the VMC-TD, an alias key pair comprising a public key and a private key;
request, by the VMC-TD, the VMC certificate chain using an initial VMC certificate that comprises the public key of the alias key pair;
establish a secure communication channel between a trusted execution environment (TEE) security manager (TSM) of the confidential computing environment and the VMC-TD by utilizing the VMC certificate chain; and
enable one or more TDs to access one or more virtual functions (VFs) of the device via the VMC-TD;
wherein the device is authenticated using the VMC certificate chain.

13. The method of claim 12, wherein to authenticate the device, the TSM is to communicate a challenge to a device host driver executing in a virtual machine monitor (VMM) hosting the one or more TDs, wherein the device host driver to communicate with the device to enable the device to send a response to the challenge back to the TSM, and wherein the response to the challenge to authenticate the device is generated by the VMC-TD utilizing the private key of the alias key pair.

14. The method of claim 12, wherein the TSM is to:
parse the full VMC certificate to obtain the TD report;
extract a VMC-TD measurement register (TDMR), a runtime measurement (RTMR) from the TD report, and the measurement of the device from at least one of the TD report or the VMC certificate;
utilize the measurement of the device to identify the device; and
utilize the TDMR and the RTMR to verify an integrity state of the VMC-TD.

15. The method of claim 12, wherein the TSM is to:
issue a command to obtain measurements from the VMC-TD; and
receive from the VMC-TD, a measurement block comprising a VMC-TD measurement register (TDMR), a runtime measurement (RTMR), and the measurement of the device from the VMC-TD, wherein the TDMR, the RTMR, and the measurement of the device are extracted from at least one of the TD report or the VMC certificate by the VMC-TD.

16. The method of claim 11, wherein responsive to an entirety of the VMC-TD being updatable, the VMC-TD is to save VMC-TD data to a secure storage area of a TD extension (TDX) module and restore the VMC-TD data to the VMC-TD after a seamless update of the VMC-TD, the TDX module comprises a security services module of the confidential computing environment that ensures that execution controls active for the one or more TDs do not allow untrusted entities to intercept TD accesses to TD-assigned resources.

17. A non-transitory computer-readable storage medium having stored thereon executable computer program instructions that, when executed by one or more processors, cause the one or more processors to perform operations comprising:
implementing, by the one or more processors, a service trust domain (TD) as a virtual microcontroller (VMC) trust domain (VMC-TD) for a device, where the VMC-TD is to support protocols for device authentication, device measurement, and device management within a confidential computing environment; and
receiving, by the VMC-TD, a VMC certificate chain that is endorsed by a startup service component comprising a trusted module of the confidential computing environment, the VMC certificate chain comprising at least one of a root certificate of the startup service component, a startup services module signing certificate, and a full VMC certificate comprising the initial VMC certificate and a TD report comprising a measurement of the device corresponding to the VMC TD.

18. The non-transitory computer-readable storage medium of claim 17, wherein the one operations further comprise:
generating, by the VMC-TD, an alias key pair comprising a public key and a private key;
requesting, by the VMC-TD, the VMC certificate chain using an initial VMC certificate that comprises the public key of the alias key pair;
establishing a secure communication channel between a trusted execution environment (TEE) security manager (TSM) of the confidential computing environment and the VMC-TD by utilizing the VMC certificate chain; and
enabling one or more TDs to access one or more virtual functions (VFs) of the device via the VMC-TD;
wherein the device is authenticated using the VMC certificate chain.

19. The non-transitory computer-readable storage medium of claim 18, wherein to authenticate the device, the TSM is to communicate a challenge to a device host driver executing in a virtual machine monitor (VMM) hosting the one or more TDs, wherein the device host driver to communicate with the device to enable the device to send a response to the challenge back to the TSM, and wherein the response to the challenge to authenticate the device is generated by the VMC-TD utilizing the private key of the alias key pair.

20. The non-transitory computer-readable storage medium of claim 18, wherein the TSM is to:
parse the full VMC certificate to obtain the TD report;
extract a VMC-TD measurement register (TDMR), a runtime measurement (RTMR) from the TD report, and the measurement of the device from at least one of the TD report of the VMC certificate;
utilize the measurement of the device to identify the device; and
utilize the TDMR and the RTMR to verify an integrity state of the VMC-TD.
